(19) United States
(12) Patent Application Publication
(10) Pub. No.: US 2013/0241194 A1
(43) Pub. Date: Sep. 19, 2013

(54) WELDLESS ALUMINUM BASED HVAC SYSTEM AND METHOD OF MAKING

(71) Applicants: Bart Petterson, Boise, ID (US); Jon Shipman, Dursley (GB)

(72) Inventors: Bart Petterson, Boise, ID (US); Jon Shipman, Dursley (GB)

(21) Appl. No.: 13/816,700

(22) PCT Filed: Aug. 12, 2011
(86) PCT No.: PCT/US2011/047630

§ 371 Date: May 22, 2013

Related U.S. Application Data
(60) Provisional application No. 61/373,754, filed on Aug. 13, 2010.
(60) Provisional application No. 61/420,146, filed on Dec. 6, 2010.
(60) Provisional application No. 61/425,595, filed on Dec. 21, 2010.
(60) Provisional application No. 61/433,469, filed on Jan. 17, 2011.

(51) Int. Cl. F16L 41/02; F16L 5/00

(52) U.S. Cl. CPC F16L 41/023; F16L 5/00
USPC 285/48; 137/15.01

(57) ABSTRACT

Disclosed is a system for assembling a weldless HVAC system which can utilize aluminum tubing. The system is made of Y connectors, tubing connectors, and sections of tubing connecting a refrigerant source with distributed cooling units. Weldless Joints are made on the job site from standard components by threading and pressing units together.

### PRIORITY/CROSS-REFERENCE TO RELATED APPLICATIONS

This application claims the benefit of the following U.S. Provisional Application Nos. 61/433,469, filed Jan. 17, 2011; 61/425,595, filed Dec. 21, 2010; 61/420,146, filed Dec. 6, 2010; and 61/373,754, filed Aug. 13, 2010, the disclosures of which are incorporated herein by this reference.

### TECHNICAL FIELD

The presently disclosed and claimed inventive concept(s) generally relates to a system and method for assembling a system for use in HVAC in buildings, and more particularly to an HVAC system based on use of aluminum tubing and the connectors that make that system possible.

### BACKGROUND

For the past 50 years or so the standard procedure for installing HVAC equipment using copper tubing has been carried out either by mechanical means (flaring copper tube and using brass unions) or by brazing/soldering. Flaring of copper tubing is notoriously unreliable and is the source of a lot of refrigerant leaks in the field. If carried out correctly flaring is a sound method. The problem is it is seldom carried out properly and failures are numerous.

In the past soldering of copper tube was commonly used and was used with some success as the refrigerants at the time were of a low pressure, typically R12, R22, R11 and methyl chloride. Even so, solder was not good in areas of vibration and high temperature and many leaks occurred. Its one saving grace from an installation point of view was that solder melts at a very low temperature so it was easy to apply and caused no internal contamination of the tube as no oxidation takes place at low temperature, therefore the tube stayed relatively clean.

Brazing of copper tube is much the preferred method of connecting field tubing as it makes a much stronger connection if carried out properly, and is suitable for all the new generation of high pressure gases that are commonly found today, R502, R134A, R410A, R407A, 410A and R407C. However, the downside of brazing is that very high temperatures are involved, typically in the 900 degrees C. range. A reasonably high level of skill is required to make sound joints, and contamination is a big issue. A new problem has also arisen in recent years regarding health and safety with the introduction of hot works permits.

In many situation now hot works permits are required before work can commence and these typically impose restrictions on when and where brazing can be carried out. This requirement translates into added costs and delays, is time consuming and inefficient and increasingly hot works are banned altogether.

When brazing takes place a huge amount of oxidation takes place inside the tube. Black soot forms from impurities in the air and this has to be combated by the purging of dry nitrogen through the tubing while the brazing is taking place. Nitrogen purging is time consuming, irksome, expensive and rarely carried out, with the result that many systems are commissioned with heavily contaminated tubing which results in a catalogue of problems later on. The main failures due to contamination are contaminated compressor oil resulting in compressor failures, blockages of small tubes in the system resulting in control box failures and valves.

An added concern is the excessive production of CO2, a greenhouse gas, during the production of copper tubes. This added expense of copper makes a system that can be adapted to tubing other than copper, such as aluminum, very desirable.

HVAC systems around the world are made using copper tubes, which are fitted into brass or copper fittings. One of these systems is called a VRF air conditioning system. Aluminum is a much cheaper material than copper, and aluminum production creates far less carbon dioxide, a major greenhouse gas, than copper production. Aluminum costs roughly half of what copper does. There is thus a huge economic and environmental incentive for making HVAC systems based on aluminum tubing. The reason that such a system has not been used in the past is that fittings were not available which would connect aluminum tubes in a way that was leak free, and connectors made of metals other than aluminum would result in galvanic corrosion between the aluminum tubing and the non-aluminum fitting. Aluminum is not amenable to brazing or welding in the field.

A major cause of thread failure within a building or process plant environment is galvanic corrosion—where the carbon steel pipe directly meets a brass valve, or is transitioned to copper pipe. Here, the microvolt difference in electrical potential of the metals will produce a small current between them—the result of which is to greatly accelerate the deterioration of the more reactive and often termed “less noble” carbon steel pipe.

In effect, an extremely small DC electrical circuit is created, with the steel pipe serving as the anode, the brass fitting or copper pipe acting as the cathode, and the water serving as a weak wire connection completing the circuit. In simplest terms, a very weak battery is created. Use of aluminum tubing with brass, copper, or steel has the same result: rapid corrosion.

“Galvanic” corrosion occurs between any two dissimilar metals in contact with each other and water, and typically attacks the steel pipe to a degree somewhat dependent upon existing corrosion conditions. Galvanic corrosion is defined as an electrochemical reaction of two dissimilar metals in the presence of an electrolyte, typically water, and where a conductive path exists. It is visually recognizable in its latter stages by some degree of deposit buildup where the dissimilar metals meet at the threads—creating a microfine leak. At that point, however, most of the damage has already occurred and replacement is required.

The global market for air-conditioning systems has risen dramatically in the last decade and looks set to continue to expand. Currently, the most advanced air-conditioning system in common use is the VRV or Variable Refrigerant Volume system.

A network of copper pipes is installed around the building to supply refrigerant from the HVAC core (refrigerant source) to the relevant cooling coils (“air handlers”, or distributed cooling units) in the required areas. As the copper pipes extend from the refrigerant source to the distributed cooling units, the copper pipes split into smaller and smaller tubes. The splitting of one tube into two, with one going to a fan coil, and the other continuing on to other fan coils, is accomplished at a y joint called a refnet in the prior art. The prior art refnet connections are welded together from a number of parts, and requires multiple welds for each Y joint. There has been no connection other than welding which ensured a leak free fitting when using copper pipes, the industry standard. The welds have to be in a nitrogen environment. With so many welds there is fire hazard, and the welds require trained and highly paid personnel to accomplish the welding. One type of refnet junction is formed from an incoming pipe that splits at the junction into two outgoing pipes. Each of the three pipes has stepped down diameters to match the requirements for that particular refnet junction. One way in which this is accomplished is to use a pipe with built in size reductions, then just cutting off the pipe in the region of pipe diameter that matches the size of the system pipe to be attached.

When the component is to be fitted, the diameter of the pipe is determined and the correct diameter section of the component is welded on. This is a cumbersome operation, especially since it is necessary to purge the weld region with nitrogen in order to prevent oxidation of the metal. Accordingly, the connection of tubing component to pipe is intricate and subsequently expensive and prone to error and fire risk, and takes an excessively long time to complete, and requires specialized and expensive technicians to build.

Besides refnet junctions, the HVAC system requires at least two other types of connections. One type joins two copper tubes together, and another type joins a flared copper tube to a brass fitting with an internal thread opposite the flared tube fitting. An aluminum tubing based HVAC system requires joints sufficiently tight that no leakage occurs and which prevents galvanic corrosion at the fittings. If this could be accomplished, a great savings in cost would be realized, an environmentally favored solution could be achieved, and projects could be built faster and cheaper.

It is an object of the present invention to provide an HVAC system based on aluminum tubing rather than copper tubing

It is a further object of the present invention to provide a type of refnet junction forming assembly to allow refnet junctions to be fabricated on the job site, without welding, to match the size and pressure specifications of the HVAC system. This on-site fabrication is designed to securely seal the system so that refrigerant gasses will not escape, eliminate all welding steps. By eliminating the welding step, the assembly is much less of a fire hazard. Such a system can also be assembled without hiring the highly skilled welders required by the prior art, and greatly shortens the fabrication time.

It is a further object of the present invention to provide a type non-conducting and non-corroding connector for connecting two aluminum pipes in a leak free junction.

It is a further object of the present invention to provide a type non-conducting and non-corroding connector for connecting an aluminum tube to a threaded fitting.

### SUMMARY

The disclosed technology allows the joining of high pressure, high pressure tubing without the use of heat for uses such as carrying refrigerant. It also allows assembling a system using joints and tubing of dissimilar metals, such as copper, steel and aluminum, while achieving an unbreakable connection that massively exceeds its field application. The disclosed technology has gained ETL listing to U.L. 207 which requires components to survive a 3000 psi pressure test which is far higher than anything practically required.

The disclosed technology system dispenses with the need for skilled brazing personnel, nitrogen purging, hot works permits and even use of copper tubing for carrying refrigerant. The disclosed technology is able to dispense with the use of expensive copper tube because of the use of dielectric coated fittings. This coating prevents the corrosion through electrolysis of the tubing and allows the joining of aluminum and copper tubing, and use of brass and steel fittings. The ability to use aluminum in high pressure refrigerant lines is the first time ever in the history of HVAC that relatively inexpensive aluminum tubing can totally replace the more expensive copper.

An HVAC system built by the disclosed technology uses computer aided design to develop the specifications of the system, and then a relatively small selection of fittings and tools are used to fabricated on-site, without welding, brazing or soldering, the multiple tubing connections in the system. One part of the system is a part that replaces the prior art refnet junction, and is called a Y or tri connector. The assembly of tools and parts which can be used to make a tri connector also serves to make other connections of tubing. The tri connector is a hub of steel, into which three steel connectors with one threaded end and one press fit end are threaded into the hub. The connectors are coated with a dielectric layer to prevent electrical contact between parts. By making the hub of steel with threaded openings, steel press-thread connectors can be assembled to form a tri connection which is totally gas proof and able to withstand high pressures. With a limited number of hubs, press-thread connectors, and press connectors, and pressing tools, and locking rings, a system can be constructed from a greatly reduced inventory of parts, on site, with no welding.

A dielectric connector designed to join different types of metal pipe together, without welding brazing or soldering, is another component of the system. For instance, if a copper tube and a steel fitting were joined, electrical separation would be necessary as the combination of metals under solder could produce galvanization, leading to corrosion and failure of the pipe. The same would be true of aluminum touching steel, or copper touching aluminum. The connector can be of several versions, but each version has a first end that presses together to hold a section of tubing. The second end of the connector can be a mirror image of the first end, or can be a threaded portion, or can be the equivalent of a flare nut. The connector is generally cylindrical and is preferably made of steel, coated inside and out with a dielectric coating. Surrounding the connector body are at least two ring-like tool ridges which encircle the connector body generally in the center of the connector body. To one side of the tool ridges is a first flange on a first end of the connector body and to the other side of the connector body is a second flange on the second end of the connector body. Each flange is encircled by a sealing ridge, and has an interior surface which extends through the connector body. On the interior surface is a ridge which is provided to abut the end of a tube inserted into the connector body. There is a first ridge on the first end and a second ridge on the second end, both in the interior surface of the connecting body. The connector body is covered inside and out with a dielectric material, namely a dielectric plastic, or some other suitable nonconducting material, which is plated onto the connector body on the interior and the exterior by an electric plating method. The dielectric material which covers the steel connector allows tubing sections of dissimilar metals to be joined to the steel connector. Thus, combinations of brass, copper, and aluminum tubing may all be joined to the steel connector without causing cathodic corrosion. The dielectric material is typically from 15-20 microns in thickness.

The use of steel connectors for the aluminum tubing allows the seal to be secure to gas leakage, by sandwiching the aluminum tubing end between an unyielding steel tubing insert and the steel connector, with pressure applied by a steel connector nut which is pressed onto the connector body. A tool gripping ridge in the middle of the connector are tool ridges and are provided for engagement by the jaws of the pressing tool. The connector, connector nut, and tubing inserts can also be zinc plated.

The disclosed technology also includes pressing tools for pressing the connector nut onto the connector body. This requires a lot of force, since the act of pressing the connector nut onto the connector body sandwiches the end of the tubing between the steel tubing insert and the inside of the connector body. The pressing tool has an upper clamp body and a lower clamp body. The two clamp body sections are attached to each other using rods for alignment, with the two clamp body sections being configured to move toward and away from each other. Springs on the rods press the two body sections apart. A hydraulic line is attached to the lower clamp body, and when activated presses the two body sections together by hydraulic force.

There is a hydraulic cylinder below each of the two rods, and the two rods form the piston in the cylinders. Hydraulic fluid enters the two cylinders, and forces the pistons toward the bottom of the lower clamp body.

Each of the lower and upper body sections have a top side, a bottom side, facing sides, outfacing sides, left sides, and right sides. Each of the body sections define a generally cylindrical passage, extending from the facing sides to the outfacing sides. This passage is a partial cylinder, and would vary in size depending on the size of the tubing and fittings being worked on.

In each of the body sections, in the semi-cylindrical passage, are located semi-cylindrical cutouts, forming support positions for the insertion of jaws. The jaws are semi-cylindrical, and have a protruding interior ridge, or tool grip ridge. The tool grip ridge is consistent with a corresponding ridge on the connector, and the ridge on each jaw presses against the ridge on the connector to press the pipe into the fitting. The joining of the aluminum or copper pipe to the fitting includes an inner locking collar also called a tube insert, which sandwiches the pipe between the wall of the fitting and the inner locking collar. An outer locking collar is simultaneously pressed onto the outside of the fitting.

A second embodiment of the disclosed pressing tool comprised of two sections which are rotationally attached to each other. Each half is polygonal in shape, such as a hexagon, and on each of several of the hexagonal sides is located a jaw sized for engagement with a tool sealing ridge of a particular size of connector. Each jaw can be for a different size of connector, and the two sections can rotate in relation to each other. Thus the two sections can be rotated to hold different sized of connectors, including connectors with two different size ends. An example of this device would be hexagonal, with different sizes of jaws on 4 to 6 of the sides.

In each of these embodiments, the sections are pressed toward each other by hydraulic means, which can be a foot pedal or a hydraulic motor. This version of the device works with smaller sized connectors than the version discussed above, and also works with connectors with different sized ends, i.e. adapters, which connect tubing of two different diameters.

In the second embodiment of the pressing tool, the two sections are joined by a rod, as in the first embodiment, with the rod surrounded by a spring which forces the two sections apart. The rod is the piston of a hydraulic cylinder and forces the two sections together when activated, to secure the pipe end between an outer locking collar, an inner locking collar, and the flange of the connector. A side of the connector is secured to a pipe end, then the connector is reversed to secure a pipe end to the other side. A locking pin secures the two parts of the rotational press, and retains their alignment as they are used to press a connection into engagement with a tubing section.

The invention also includes a method of forming HVAC systems using weldless joints and aluminum tubing or other similar metals to form the system. The steps of the method include analyzing the HVAC needs of a building and determining the required configuration of the refrigerant source(s), the distributed cooling units and the tubing network that is required to join them and provide adequate refrigerant capacity. The tubing network includes sections of tubing, which would typically be aluminum tubing, connectors which join two tubing sections together, and connector hubs which form a Y and allow a refrigerant line to be split into two and subsequently other tubing lines.

Once the cooling needs of a building are analyzed the physical position of each Y connection is determined using the building plans. The next step is building each Y connection with the three hub connectors that come out of the connector hub, being sized to the appropriate size and ready to be connected to tubing sections. The next step is attaching hub connectors into the connector hub, with each hub connector having a dielectric layer outside and inside, and a press fit first end and threaded second end. The threaded second end is threaded into the connector hub.

The next step is cutting sections of aluminum tubing to connect the source of refrigerant to the Y connections and to the distributed cooling units.

The next step is forming joints between aluminum tubing and the Y connectors by inserting a tubing insert in the end of the tubing sections, placing a connector nut on each end of the tubing sections, placing the tubing end in a connector body on the press fit end of the connectors, and pressing the connector onto the connector body to form a tight, weldless joint without the addition of heat to form a joint.

The next step is determining where sections of tubing need to be connected to other sections of tubing, including locations where the tubing diameter needs to change in the pathway of the refrigerant.

The next step is forming joints between the aluminum tubing sections by the use of the tubing connectors, using the tubing insert and the connector nut as described above.

The invention is also a method of joining tubing sections in order to assemble a refrigeration system, which is made of the following steps:

The first step is inserting a tube insert into the end of a first tube section to be joined to a second tube section.

The next step is placing a connector nut onto the first tube end and sliding it a short distance up the first tube end.

The next step is applying a locking preparation fluid on a portion of the tube end, on an exterior surface of the tube end.

The next step is placing the tubing end into a connector flange of a connector body, with the connector made of steel and being a generally cylindrical tubing connector body as described above. The tubing is placed so that it rests against the ridge on the interior of the connector.

The next step is placing the first tube, and the tube insert with the locking ring on the first tube, into a two piece press with the press including a first jaw for engagement with the outer end of the connector nut, and a second jaw for engagement with one of the tool grip ridges on the connector.

The next step is developing hydraulic pressure for pressing the two pieces of the press together and forcing the connector nut over the connector flange, with one end of the tube sandwiched between the tube insert and the inside of the connector flange. Hydraulic pressure may be developed by a foot press or by other hydraulic press means. A foot press is advantageous because it can be used on a job site which does not yet have electricity.

The next step is repeating these steps on the end of a second tube, so that two tubes are joined to the connector. Using the steel connector, coated with a dielectric material, dissimilar metals may be joined together. For instance, any combination of brass, copper, or aluminum tubes may be joined in this manner to the connector, and not cause cathodic corrosion of the connector or of the tubings. The result of this adaptability in the use of materials results in refrigeration and HVAC systems finally being able to use aluminum tubing, which has never been the case before and which will revolutionize the industry. Aluminum is less costly than copper, and this method eliminates the need for welding the joints in HVAC systems. The cost savings in the industry will drive widespread adoption of this technology.

The method can also include the steps of using zinc plated tube inserts and connector nuts, with the zinc plated to a thickness of approximately 8 microns.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a view of the overall HVAC system.

FIG. 2 is an exploded view showing a tubing connector and connector nuts.

FIG. 3 is a cutaway view of a disclosed hub connector.

FIG. 4 is a cutaway view of a disclosed tubing connector.

FIG. 5 is a joint of the system, with two tubing sections which can be dissimilar metals or different sizes.

FIG. 6 is a disclosed Y connection.

FIG. 7 is a view of a prior art refnet junction.

FIG. 8 is a side cross section of a disclosed flare nut connection.

FIG. 9 is a side cross section of a disclosed flare nut connection.

FIG. 10 is a view of a tubing end and a tubing insert, part of the method of joining aluminum tubing in a weldless joint.

FIG. 11 is a view of a tubing end and a tubing connector, part of the method of the joining aluminum tubing in a weldless joint.

FIG. 12 is a view of a connector nut sliding onto a connector body, part of the method of joining aluminum tubing in a weldless joint.

FIG. 13 is a view of a joint formed on a tubing end, part of the method of joining aluminum tubing in a weldless joint

FIG. 14 is a view of a tubing connector joining two sections of tubing, part of the method of joining aluminum tubing in a weldless joint

FIG. 15 is a view of a disclosed tool for forming joints.

FIG. 16 is a view of a disclosed tool for forming joints.

FIG. 17 shows the steps in the method of forming of an HVAC system with weldless joints.

### DETAILED DESCRIPTION OF PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

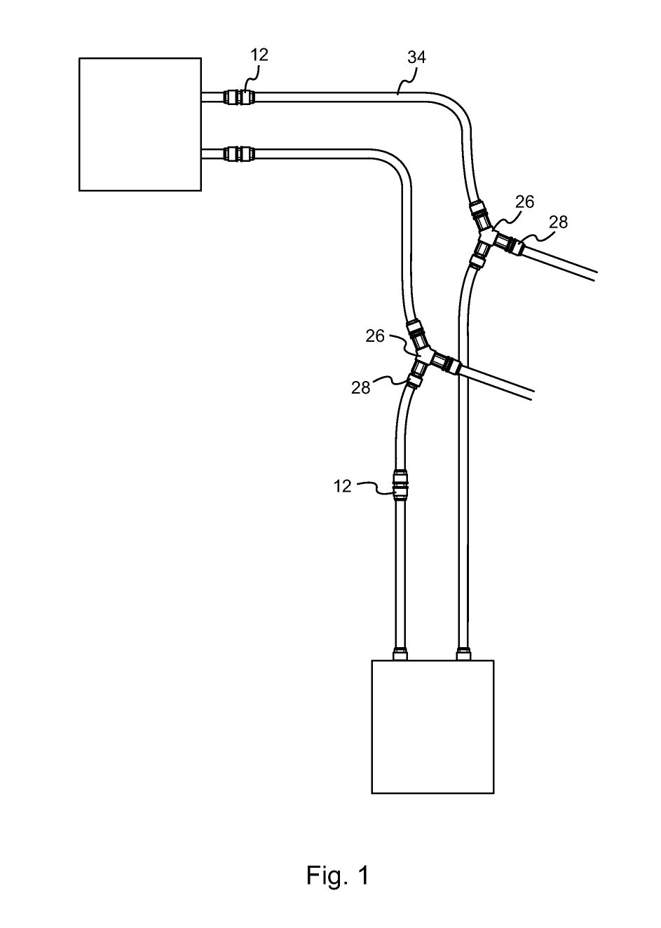

Shown in FIG. 1 is a diagram of a refrigerant system of the disclosed technology. Also shown in FIG. 1 are links of tubing 34, which are connected to fittings with a connector 12, which may be of the type designated a press-press connector, which refers to both ends of the connector being a press fitting. The system also includes connectors which are press/thread connectors in which one end of the connector is joined to tubing by pressing, and the other end is joined to a fitting by threads. Shown are Y connectors 26, which involve the use of press-thread connectors 28. Each of these fittings will be discussed as they appear in more detail in this document. The system as a whole is made up of parts which are configured to be assembled on a job site without welding. All of the fittings together form a system which is capable of holding a very high pressure, which involves the use of dissimilar metals, with each of the fittings and tubing sections configured to be connected to each other in a corrosion free high pressure joint, and to be assembled on the job site with no requirement for welding.

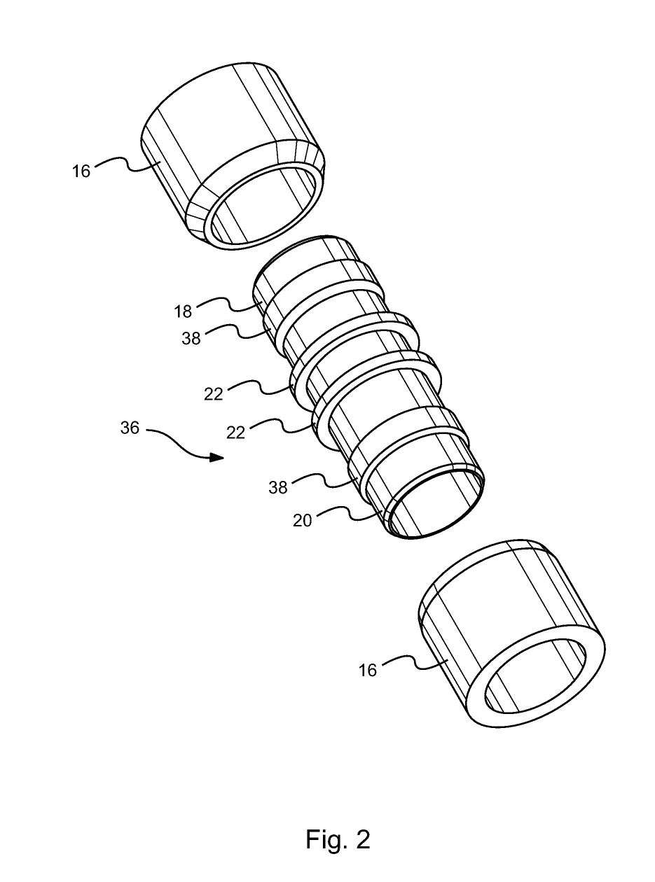

FIG. 2 shows a press-press connector 36, of the invention. At either end of the press-press connector, are shown connector nuts 16, which would typically be uncoated steel rings. Each of the connector nuts 16, are joined to the press-press connector 36, by being pressed on to the first end 18, and to a second end 20, of the connector body. The connector body is preferably a steel fitting which is covered inside and out by a dielectric coating 24, which insulates the connector from electrical discharges and corrosion from the tubing. This feature allows dissimilar materials to be used in the system, such as aluminum tubing connected to steel fittings, and optionally with copper tubing or brass fittings. The press-press connector 36, includes a tool gripping ridge 22, on each end of the connector. The connector also includes a sealing ridge 38, on each end of the connector. The press-press connector 36 can be in different sizes, depending on the requirements of the system. A typical HVAC system using the disclosed technology might be comprised of thousands of Y connectors and press-press connectors 36, and numerous press-thread connectors 28.

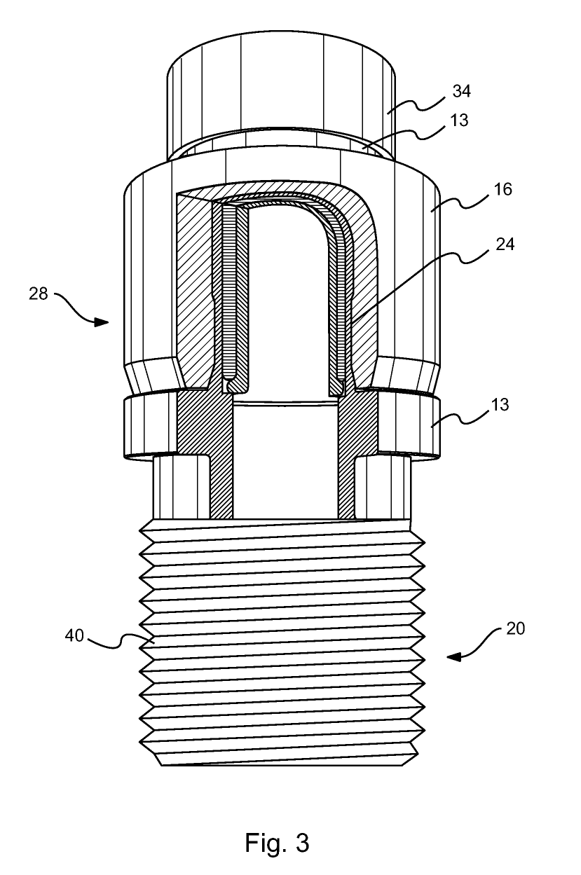

FIG. 3 shows a press-thread connector 28, which is identical on one end to the press-press connector 36, but has a thread section 40, on the second end 20, of the device. Included in the press-thread connector 28, is a connector body 13, preferably made of steel and coated with a dielectric layer 24, which may be seen in this cross-sectional view. The connector body 13, extends through the connector nut 16, and is visible on the outside of the connector nut 16. Attached to the connector body is a section of tubing 34. A number of different types of tubing 34, may be utilized including copper, but an important contribution of the disclosed technology system is the ability to utilize aluminum tubing in a high pressure refrigerant carrying application. Present in the threaded part of the hub connector is a seal and o ring for completing the joint.

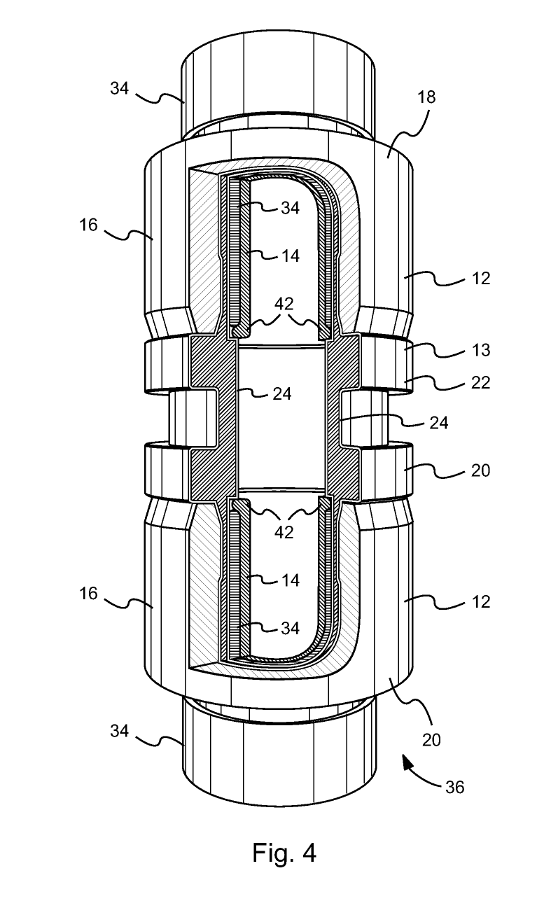

Shown in FIG. 4 is a press-press connection 36. It includes a connector body 13, and a connector 12, at each of the first end 18, and the second end 20. Shown are two (2) lengths of tubing 34, which are joined by the connector 12. Each piece of tubing 34 surrounds a tubing insert 14, at the end of the tubing. The tubing insert 14, has a lip 42, which prevents the tubing insert from entering the inside of the tube 34, and which positions it on the end of each of the tubing 34.

Shown in FIG. 4 are connecting nuts 16, which are positioned surrounding and circumvolving the first end 18, and the second end 20, of the connector body, and securing in place the ends of the tubing sections 34. Each end of the connector body 13, includes a tool gripping ridge 22, which is utilized in forming the joint, and which allows a pressing tool to apply the pressure that seats the connector nut 16, on to the connector body 13. FIG. 4 also shows a dielectric layer 24, which coats the inside and the outside of the connector body 13. The dielectric layer 24, is preferably a layer approximately 10 to 24 microns thick, which is deposited by an electrical process. A suitable material for use in the dielectric coating 24, has been found to be electrophoretic paint, but other materials with similar properties would also be suitable.

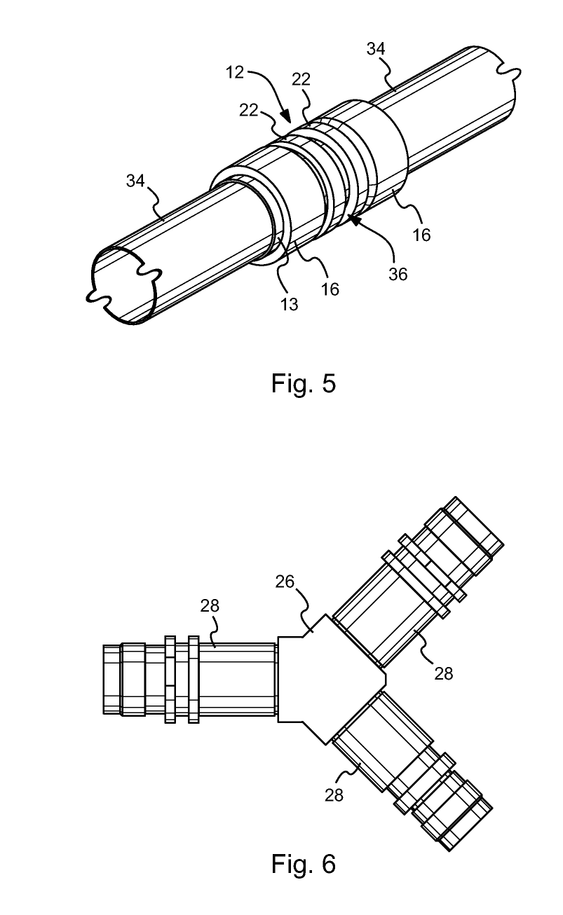

FIG. 5 shows a connector 12, which joins tubing sections 34, at a high pressure corrosion free joint. Visible in this Fig. are the connector nuts 16, at either end of the press-press connector 36, with the tool gripping ridges 22, visible and a part of the connector body 13, extending out from the connector nut 16. In a fitting such as that as shown in FIG. 5, one (1) section of tubing may be aluminum, another section may be copper, or other materials may be securely attached to each other without a problem with galvanic corrosion.

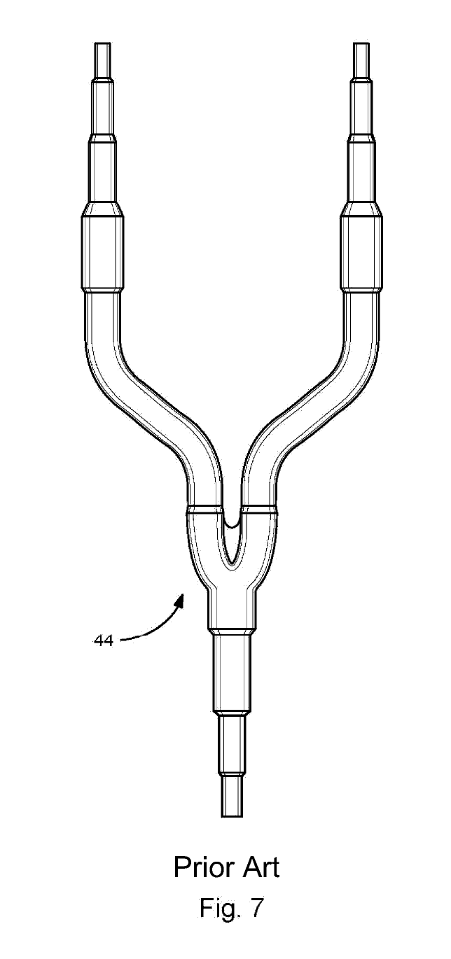

FIG. 6 shows a Y connector 26, of the disclosed technology. The Y connector 26, is preferably steel, and may be coated with a dielectric coating or layer. The Y connector 26, is preferably formed with three (3) threaded openings, into which three (3) press-thread connectors 28, may be inserted and secured. A common use of the Y connectors is to change the diameter of the outgoing tubing to a smaller size than the incoming tubing, which would be determined by the engineering calculations of the refrigerant system. The Y connector 26, of FIG. 6 may be contrasted with a prior art refnet junction 44, which is shown in FIG. 7. In prior art refnet junctions, an incoming pipe enters the junction and two (2) outgoing pipes leave the junction. Each of the pipes have step down diameters so the operator may choose the section of tubing with the required diameter, cut it off at that point and connect the tubing, and weld on a joint that connects to tubing of the appropriate diameter. As noted above, use of prior art refnet junction 44, requires multiple welding steps, nitrogen purging, pressure testing and other time consuming and expensive steps.

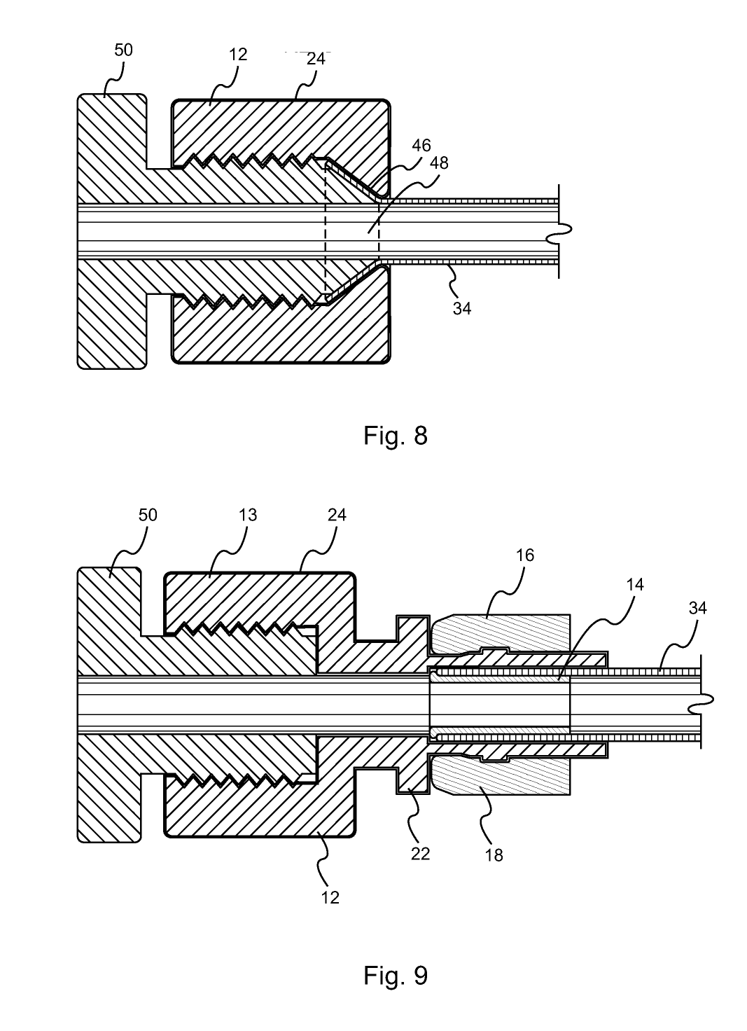

Shown in FIG. 8 and FIG. 9 are two (2) types of connectors 12, of the disclosed technology, which are adapted for use as flare nuts. FIG. 8 shows a connector 12, with a dielectric coating 24, which covers the inside and the outside of the connector 12. In this particular version of the connector, a generally conical flare seat 46, is present, which fits the flared end 48, of the tubing section 34. Because the flare seat 46 is covered with the dielectric coating 24, the connector 12, may be any material, such as brass or steel and the tubing 34, may also be dissimilar materials such as copper or aluminum. In this example, a brass male piece 50, may be screwed in to the threaded interior of the connector 12. The brass male piece 50, is equivalent to prior art portions of a brass flare nut.

FIG. 9 shows another version of a connector which acts in an equivalent manner as a prior art flare nut. Present in this embodiment is a section of tubing 34, which does not have a flared end 48. Instead it ends in an un-flared end and is locked in place by the connector nut 16, a tubing insert 14, and a first end 18, of a connector as has been described previously. This connector has a tool gripping ridge 22. The connector body 13, may be coated on the inside and outside with the dielectric coating 24, as described in previous connectors.

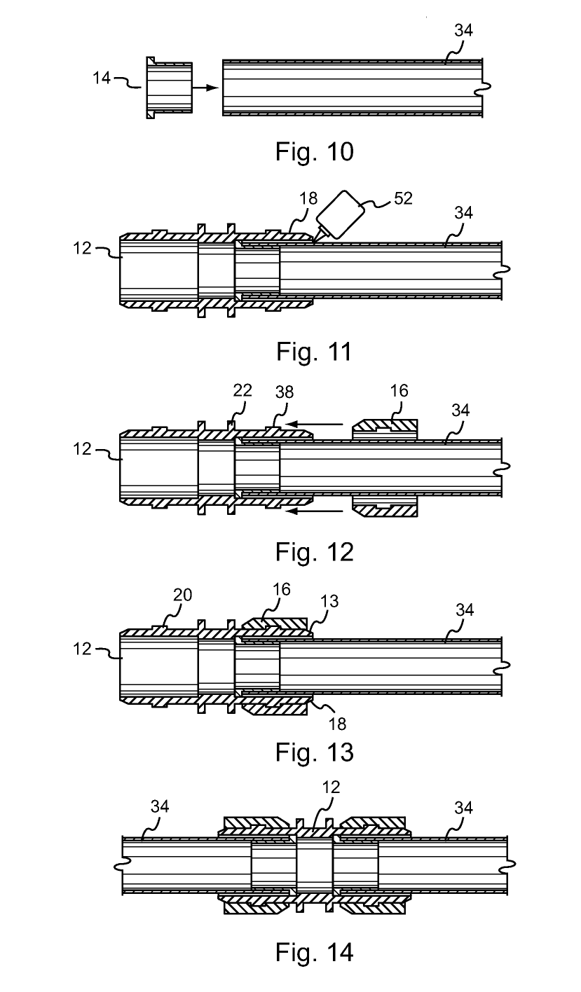

Shown in FIGS. 10 through 15 is the sequence in which two (2) sections of tubing 34, are joined together. In FIG. 10, a section of tubing 34, is cut off with leaving a square end. It is reamed with a tool in order to make the interior wall smooth, and a tubing insert 14, is placed in the end of the tubing section 34. FIG. 11 shows a connector 12, being placed loosely over the end of the tubing section 34, in which the tubing insert 14, is placed at the end. In this loose fitting, the end of the first end 18, of the connector is marked with a marker 52, to identify the correct positioning of the connector when it is fully inserted on to the end of the tube section 34.

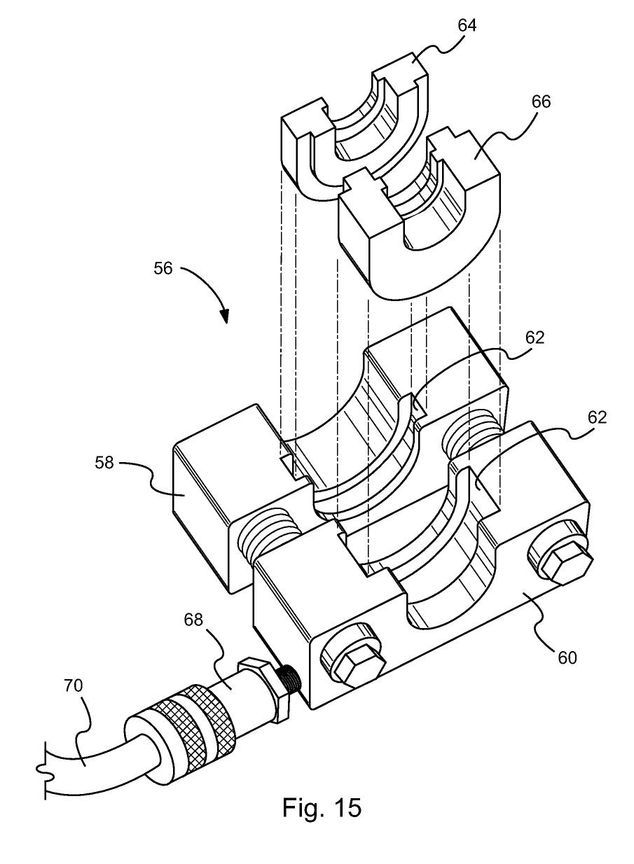

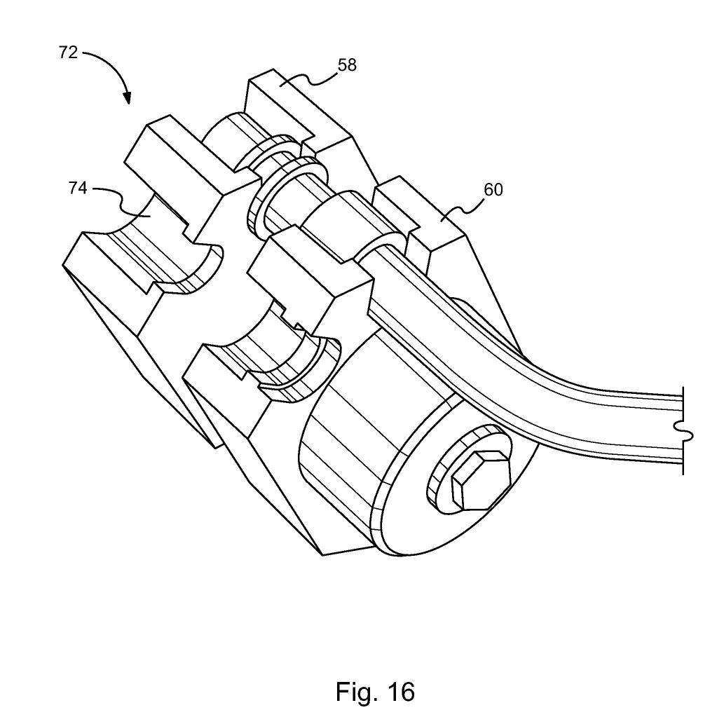

After marking as shown in FIG. 11, the connector 12, is removed, and a connector nut 16, is slid on to the tubing section 34. Once the tubing connector nut 16, is placed on the tubing section 34, the connector 12, is slid back in to place over the end of the tubing section 34. A small amount of Locktite sealant is first placed on the end of the tubing section 34, to help with the sealing of the tubing to the inside of the connector 12. A small amount of lubricant is also placed on the sealing ridge 38, of the connector 12. With the connector on the end of the tubing section 34, the connector nut 16, is pressed on to the sealing ridge 38, of the connector, until it is in contact with the side of the tool gripping ridge 22, or close to contact. A preferred dielectric coating has lubricant built into the layer, but a lubricant can also be applied. This position is shown in FIG. 13, with the tubing 34, attached to a first end 18, of the connector body, and with part of the connector body 13, extending beyond the connector nut 16. The same process is utilized on the second end 20, of the connector nut 12, and two (2) tubing sections 34, are joined to the connector 12, as shown in FIG. 14. Shown in FIG. 15 is a pressing tool of the disclosed technology which presses a connector nut on to an end of a connector. The pressing tool has a first half and a second half which are spaced apart from each other, and move toward each other under hydraulic pressure. The first half and the second half shown in FIG. 15 is a pressing tool 56, which includes a first half 58, and a second half 60. Each half has a jaw receiver 62, which is a generally semi-circular recess which has contours which fit a first jaw 64, and a second jaw 66. When the jaws 64 and 66 are in place in the jaw receiver 62, a connector 12, is fitted with a tubing section 34, and a tubing insert 14, may be placed in the jaws, and a connector nut 16, is pressed on to the sealing ridge 38, of the connector body 13. Hydraulic pressure may be applied through a hydraulic fitting 68, and a hydraulic line 70, which goes to a pump (not shown). Once the connector nut 16, is pressed on to one (1) side of a connector, another tubing 34, may be pressed on to the other side of a press-press connector.

FIG. 16 shows a different type of pressing tool which is designated as 72. The pressing tool 72, also has a first half 58, and a second half 60, and is further provided with built-in jaws 74. The first half is configured to rotate around the second half, and the built-in jaw 74, may be designed for a number of different sizes of connectors 12. Using the pressing tool 72, a connector which joins different sizes of tubing may be pressed together and form an adaptor between different sizes of tubing.

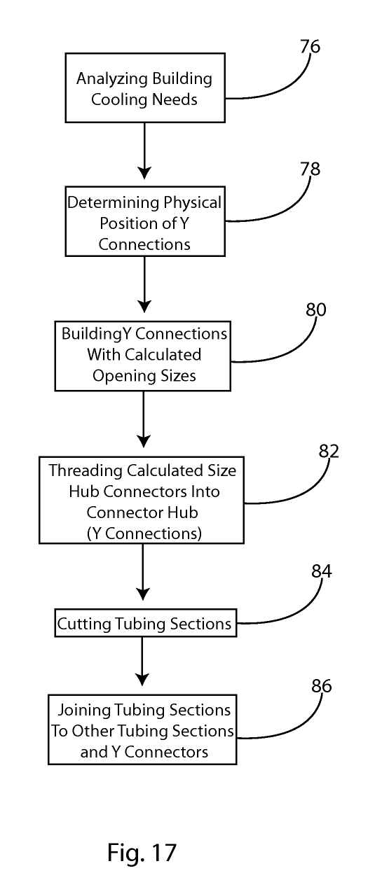

FIG. 17 shows the steps of forming of an HVAC system with weldless joints forming part of the method of joining aluminum tubing in a weldless joint. The steps include, 76 analyzing a building HVAC system to determine the required number, placement, and sizing of each Y connection in the system, to deliver a calculated amount of refrigerant to a plurality of distributed cooling units; 78, establishing a physical position of each Y connection in the physical building; 80, building each Y connection called for using an appropriately sized Y connector hub, with predetermined sizes of threaded opening, and selected hub connectors threaded into said connector hub; 82, attaching by threading appropriately sized hub connectors into said connector hub, with each hub connector having a dielectric layer inside and outside, and a press fit first end and a threaded second end, with the threaded second end threaded into the connector hub; 84, cutting section of aluminum tubing to connect a source of said refrigerant to said Y connections and to said distributed cooling units; 86, forming joints between said aluminum tubing sections and said Y connectors by inserting a tubing insert in an end of said tubing sections, placing a connector nut on each of said end of tubing sections, placing said tubing end in a connector body on said press fit end of said connector, pressing said connector nut onto said connector body to form a tight, weldless joint without addition of heat to form a joint; determining where sections of tubing need to be connected other sections of tubing, including where tubing diameter changes; and 86, forming joints between said aluminum tubing sections by use of tubing connectors which form leak proof joints with addition of heat to form said joint, by inserting a tubing insert in an end of said aluminum tubing sections, placing a connector nut on each of said end of aluminum tubing sections, placing said tubing end in a connector body on said press fit end of said connectors, pressing said connector nut onto said connector body to form a tight, weldless joint with addition of heat, as in welding, soldering, or brazing.

While certain exemplary embodiments are shown in the Fig's and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1-18. (canceled)

19. An HVAC system, comprising:
a plurality of tubing sections connecting a source of refrigerant to a plurality of distributed cooling units;
a plurality of Y connectors for attachment to said tubing sections with each Y connection comprising a Y connector hub with three threaded hub openings, and three hub connectors for threading into each of said threaded hub openings, with said hub connectors having a dielectric layer on an inner surface and on an outer surface and a press fit joint on a first end, and a thread fit joint on a second end, for attachment to said tubing sections to said Y connector hub; and
a plurality of generally cylindrical hollow tubing connectors with a dielectric coating layer on an inner surface and on an outer surface, with said tubing connectors having a press fit joint on a first end and a press fit joint on a second end, for joining two tubing sections; wherein
said tubing sections, said Y connectors and said tubing connectors form a network of tubing sections to deliver and return predetermined quantities of refrigerant from said source of refrigerant to said distributed cooling units, with said system comprising press fit and thread fit joints assembled without addition of heat to form the joints.

20. The HVAC system of claim 19, in which said press fit joints further comprise a tubing insert configured for placement inside an end of said tubing section, with said hub and tubing connectors having a connector body configured for placement over said end of said tubing section, and a connector nut configured for sliding engagement over said connector body, with said connector nut pressing said end of tubing section between said tubing insert and said connector body, with said dielectric coating layer preventing electrical contact between said tubing section and said connector body, with said joint configured for assembly by pressing and without addition of heat to form said joints.

21. The HVAC system of claim 20 in which said tubing sections and said connectors may be of dissimilar metals.

22. The HVAC system of claim 20 in which said dielectric material is a layer of nonconducting material electrically deposited on said connector and bonded to said connector body.

23. The tubing connection system of claim 20 in which said dielectric layer is from 15 to 25 microns in thickness.

24. The HVAC system of claim 22 in which said dielectric material is an electrophoretic paint.

25. The tubing connection system of claim 19 in which said dielectric material is a plastic.

26. An HVAC system, comprising:
a plurality of tubing sections connecting a source of refrigerant to a plurality of distributed cooling units;
a plurality of Y connectors for attachment to said tubing sections with each Y connection comprising a Y connector hub with three threaded hub openings, and three hub connectors for threading into each of said threaded hub openings, with said hub connectors having a dielectric layer on an inner surface and on an outer surface and a press fit joint on a first end, and a thread fit joint on a second end, for attachment to said tubing sections to said Y connector hub; and
a plurality of generally cylindrical hollow tubing connectors with a dielectric coating layer on an inner surface and on an outer surface, with said dielectric coating layer preventing electrical contact between said tubing section and said connector body, in which said press fit joints further comprise a tubing insert configured for placement inside an end of said tubing section, with said hub and tubing connectors having a connector body configured for placement over said end of said tubing section, and a connector nut configured for sliding engagement over said connector body, with said connector nut pressing said end of tubing section between said tubing insert and said connector body, with said joint configured for assembly by pressing and without addition of heat to form said joints;
with said tubing connectors having a press fit joint on a first end and a press fit joint on a second end, for joining two tubing sections; wherein
said tubing sections, said Y connectors and said tubing connectors form a network of tubing sections to deliver and return predetermined quantities of refrigerant from said source of refrigerant to said distributed cooling units, with said system comprising press fit and thread fit joints assembled without addition of heat to form the joints, and in which said tubing sections and said connectors may be comprised of dissimilar metals.

27. The HVAC system of claim 26 in which said dielectric material is a layer of nonconducting material electrically deposited on said connector and bonded to said connector body.

28. The tubing connection system of claim 27 in which said dielectric layer is from 15 to 25 microns in thickness.

29. The HVAC system of claim 26 in which said dielectric material is an electrophoretic paint.

30. The tubing connection system of claim 26 in which said dielectric material is a plastic.

31. The HVAC system of claim 26 in which said connector body further comprises a raised sealing ridge on an outside of said connector body, for maximizing pressure between said connector nut to said tubing insert.

32. The HVAC system of claim 26 in which said threaded openings of said Y connector hubs are of different sizes for receiving different sizes of threaded hub connectors.

33. The HVAC system of claim 26 in which said tubing connectors have a different sized connector body on said first end and said second end.

34. The HVAC system of claim 26 in which said press fit connector body ends further comprise a tool gripping ridge, configured to assist a tool in pressing said connector nut onto said connector body.

35. An HVAC system, comprising:
a plurality of tubing sections connecting a source of refrigerant to a plurality of distributed cooling units, with said tubing sections comprised of aluminum tubing;
a plurality of Y connectors for attachment to said tubing sections with each Y connection comprising a Y connector hub with three threaded hub openings, and three hub connectors for threading into each of said threaded hub openings, with said hub connectors having a dielectric layer on an inner surface and on an outer surface and a press fit joint on a first end, and a thread fit joint on a second end, for attachment to said tubing sections to said Y connector hub; and
a plurality of generally cylindrical hollow tubing connectors with a dielectric coating layer on an inner surface and on an outer surface, with said dielectric coating layer of between 15 and 25 microns in thickness, preventing electrical contact between said tubing section and said connector body, in which said tubing connectors comprise a raised sealing ridge on an outside of said connector body, and a tool gripping ridge on said outside of said connector body, and a tubing insert configured for placement inside an end of said tubing section, with said connector body configured for placement over said end of said tubing section, with a connector nut configured for sliding engagement over said connector body, with said connector nut pressing said end of tubing section between said tubing insert and said connector body, with said joint configured for assembly by pressing and without addition of heat to form said joints;
with said tubing connectors having a press fit joint on a first end and a press fit joint on a second end, for joining two aluminum tubing sections; wherein
said tubing sections, said Y connectors and said tubing connectors form a network of tubing sections to deliver and return predetermined quantities of refrigerant from said source of refrigerant to said distributed cooling units, with said system comprising press fit and thread fit joints assembled without addition of heat to form the joints, and in which said tubing sections and said connectors may be comprised of dissimilar metals.

36. The HVAC system of claim 35 in which said Y connector hub, said tubing inserts, and said connectors are made of steel, and said tubing sections are made of aluminum.

37. The HVAC system of claim 35 in which said tubing insert further comprises an outward facing lip, which prevents said tubing insert from slipping inside said end of tubing section.

38. A method of forming of an HVAC system with weldless joints, comprising the steps of:
analyzing a building HVAC system to determine the required number, placement, and sizing of each Y connection in the system, to deliver a calculated amount of refrigerant to a plurality of distributed cooling units;
establishing a physical position of each Y connection in the physical building;
building each Y connection called for using an appropriately sized Y connector hub, with predetermined sizes of threaded openings, and selected hub connectors threaded into said connector hub;
attaching by threading appropriately sized hub connectors into said connector hub, with each hub connector having a dielectric layer inside and outside, and a press fit first end and a threaded second end, with the threaded second end threaded into the connector hub;
cutting sections of aluminum tubing to connect a source of refrigerant to said Y connections and to said distributed cooling units;
forming joints between said aluminum tubing sections and said Y connectors by inserting a tubing insert in an end of said tubing sections, placing a connector nut on each of said end of tubing sections, placing said tubing end in a connector body on said press fit end of said connectors, pressing said connector nut onto said connector body to form a tight weldless joint without addition of heat to form a joint;
determining where sections of tubing need to be connected to other sections of tubing, including where tubing diameter changes; and
forming joints between said aluminum tubing sections by use of tubing connectors which form leak proof joints without addition of heat to form said joint, by inserting a tubing insert in an end of said aluminum tubing sections, placing a connector nut on each of said end of aluminum tubing sections, placing said tubing end in a connector body on said press fit end of said connectors, pressing said connector nut onto said connector body to form a tight weldless joint without addition of heat.

39. A method of joining tubing sections, comprising the steps of:
inserting a tube insert into an end of a first tube section to be joined to a second tube section;
placing a connector nut onto said first tube end and sliding it up the tube a short distance;
applying locking preparation fluid on a portion of said tube end;
placing said tubing end into a connector body of a tubing connector, in which said connector is made of steel with a generally cylindrical tubular connector body with a first end and a second end, and at least one tool gripping ridge for each end, with said tool gripping ridges encircling said connector body generally in the center region of said connector body, with said connector body having a first connector body on said first end and a second connector body on said second end of said connector, said connector body having an interior surface and an exterior surface, with a first ridge on said interior surface in said first end, and a second ridge on said interior surface in said second end, with said connector body covered inside and out with a dielectric material, enabling said connector to join sections of dissimilar metal tubing;
placing said first tube, connector and tube insert and locking nut into a two piece press, said press including a first jaw for engagement with an end of said connector nut, and a second jaw for engagement with one of said tool grip ridges;
pressing the two pieces of said press together and forcing said connector nut over said connector flange, with said end of tube sandwiched between said tube insert and the inside of said connector body; and
repeating these steps on the end of said second tube, to join the two tubes at the connector, with the steel connector configured for joining tubing sections which may be of a dissimilar metal to each other or to the connector.
